(19) United States
(12) Patent Application Publication
(10) Pub. No.: US 2023/0055808 A1
(43) Pub. Date: Feb. 23, 2023

(54) SCROLL COMPRESSOR WITH A COMPRESSION SECTION MADE OF SOLID SOLUTION STRENGTHENED FERRITIC DUCTILE IRON

(71) Applicant: Danfoss Commercial Compressors, TREVOUX (FR)

(72) Inventors: Mickael BRON, Nordborg (DK); YUSONG SUN, Nordborg (DK); Sanxiang LIU, Nordborg (DK); Laure FLORIMOND, Nordborg (DK)

(21) Appl. No.: 17/785,627

(22) PCT Filed: Oct. 29, 2020
(86) PCT No.: PCT/EP2020/080350

§ 371 Date: Jun. 15, 2022

(30) Foreign Application Priority Data
Dec. 30, 2019 (CN) 201911402997.2

(51) Int. Cl. F04C 18/02; C21C 1/10; C22C 37/04; C22C 37/10

(52) U.S. Cl. CPC F04C 18/0246; C21C 1/10; C22C 37/04; C22C 37/10; F04C 18/0215; F04C 2230/21; F04C 2240/20; F05C 2201/0442

(57) ABSTRACT

A scroll compressor (1) including an enclosure (2); a compression section (6) arranged within the enclosure (2), the compression section (6) has a fixed scroll element (7) having a first baseplate (11) and a first wrap portion (12) extending from the first baseplate (11), and an orbiting scroll element (8) having a second baseplate (13) and a second wrap portion (14) extending from the second baseplate (13), the fixed and orbiting scroll elements (7, 8) being intermeshed to form compression chambers (15); and a driving section (16) coupled with the orbiting scroll element (8) for moving the orbiting scroll element (8) in an orbiting motion during operation of the scroll compressor (1). At least one of the fixed and orbiting scroll elements (7, 8) is made of solid solution strengthened ferritic ductile iron.

### CROSS-REFERENCE TO RELATED APPLICATION

This application is a National Stage application of International Patent Application No. PCT/EP2020/080350, filed on Oct. 29, 2020, which claims priority to Chinese Application No. 201911402997.2, filed Dec. 30, 2019, each of which is hereby incorporated by reference in its entirety.

### TECHNICAL FIELD

The present invention relates to a scroll compressor, and in particular to a scroll compressor having a compression section at least partially made of ductile cast iron.

### BACKGROUND

As known, a scroll compressor comprises:
an enclosure,
a compression section arranged within the enclosure, the compression section comprising a fixed scroll element having a first baseplate and a first wrap portion extending from the first baseplate, and an orbiting scroll element having a second baseplate and a second wrap portion extending from the second baseplate, the fixed and orbiting scroll elements being intermeshed to form compression chambers, and
a driving section coupled with the orbiting scroll element for moving the orbiting scroll element in an orbiting motion during operation of the scroll compressor.

The fixed and orbiting scroll elements are generally made of grey cast iron because such a material is easy to machine, has good vibration dampening, good thermal properties and low production cost.

However, due to grey cast iron's structure, such a material has a low mechanical strength which requires to increase the thickness of the fixed and orbiting scroll elements in order to avoid a breaking of the latter during compressor operation.

Thereby in recent years, some scroll elements have been made of ductile cast iron having a matrix made of pearlite and ferrite. Such a material allows to obtain a scroll element having a compact structure and an improved mechanical strength. However, using ductile cast iron having a matrix made of pearlite and ferrite substantially increases machining time and substantially decreases cutting tool life, which leads to a poor productivity of the machining process of the scroll elements.

### SUMMARY

It is an object of the present invention to provide an improved scroll compressor which can overcome the drawbacks encountered in conventional scroll compressors.

Another object of the present invention is to provide a scroll compressor having a compression section which has an improved mechanical strength and which ensures an improved machinability.

According to the invention such a scroll compressor comprises:
an enclosure,
a compression section arranged within the enclosure, the compression section comprising a fixed scroll element having a first baseplate and a first wrap portion extending from the first baseplate, and an orbiting scroll element having a second baseplate and a second wrap portion extending from the second baseplate, the fixed and orbiting scroll elements being intermeshed to form compression chambers, and
a driving section coupled with the orbiting scroll element for moving the orbiting scroll element in an orbiting motion during operation of the scroll compressor,

wherein at least one of the fixed and orbiting scroll elements is made of solid solution strengthened ferritic ductile iron (SSFDI), also called solid solution strengthened ferritic spheroidal graphite cast iron.

Using solid solution strengthened ferritic ductile iron to manufacture at least one of the fixed and orbiting scroll elements allows to improve machinability of said at least one of the fixed and orbiting scroll elements notably due to the addition of silicon, and thus to improve cutting tool life.

In addition, using solid solution strengthened ferritic ductile iron to manufacture at least one of the fixed and orbiting scroll elements allows increase tool life, which leads to an improve productivity compared to the one obtained with standard ductile cast irons having a matrix made of pearlite and ferrite.

Furthermore, compared to standard ductile cast irons having a matrix made of pearlite and ferrite, solid solution strengthened ferritic ductile iron has a higher elongation at fracture and a homogeneous matrix.

Therefore, the compression section according to the present invention has an improved mechanical strength while ensuring an improved machinability.

The scroll compressor may also include one or more of the following features, taken alone or in combination.

According to an embodiment of the invention, the solid solution strengthened ferritic ductile iron has a tensile strength Rm between 400 and 650 MPa, advantageously between 425 and 625 MPa, and for example of approximately 450, 500 or 600 Mpa.

According to an embodiment of the invention, the solid solution strengthened ferritic ductile iron has a silicon content between 2.5% and 5%, and advantageously between 2.8 and 4.5%, and for example between 3 and 4.5%. Such a silicon content allows to obtain a scroll element having a homogenous structure.

According to an embodiment of the invention, the solid solution strengthened ferritic ductile iron has a copper content between 0.030% and 0.050%, and advantageously between 0.032 and 0.042%.

According to an embodiment of the invention, the solid solution strengthened ferritic ductile iron has an elongation of at least 8%.

According to an embodiment of the invention, the solid solution strengthened ferritic ductile iron has an elongation between 8% and 24%, and advantageously between 8% and 20%, and for example of approximately 10, 14 or 18%.

According to an embodiment of the invention, the solid solution strengthened ferritic ductile iron has a 0.2 yield strength between 330 and 500 MPa, and for example of 350, 400 or 470 MPa.

According to an embodiment of the invention, the matrix of the solid solution strengthened ferritic ductile iron predominantly contains ferrite. In other words, the metallographic microstructure of the solid solution strengthened ferritic ductile iron predominantly contains ferrite. Ferrite allows to obtain a scroll element having a homogenous structure and to ensure a good cutting tool life.

According to an embodiment of the invention, a maximum pearlite content in the matrix of the solid solution strengthened ferritic ductile iron is of 5%.

According to an embodiment of the invention, the matrix of the solid solution strengthened ferritic ductile iron contains at least 85% of ferrite, and for example at least 95% of ferrite. Advantageously, the matrix of the solid solution strengthened ferritic ductile iron only contains ferrite.

According to an embodiment of the invention, the microstructure of the solid solution strengthened ferritic ductile iron has a homogenous ferritic matrix.

According to an embodiment of the invention, the microstructure of the solid solution strengthened ferritic ductile iron has a graphite shape of type V or of type VI.

According to an embodiment of the invention, the microstructure of the solid solution strengthened ferritic ductile iron has a nodularity of at least 75%, and for example of at least 80%.

According to an embodiment of the invention, the solid solution strengthened ferritic ductile iron has a Poisson's ratio between approximately 0.28 and approximately 0.29.

According to an embodiment of the invention, the solid solution strengthened ferritic ductile iron has an elasticity modulus of 170 GPa.

According to an embodiment of the invention, the solid solution strengthened ferritic ductile iron has a rotation-endurance bending strength at 20° C. between 200 and 230 MPa, and for example of 210 MPa or of 225 MPa.

According to an embodiment of the invention, the solid solution strengthened ferritic ductile iron has a Brinell hardness between 170 and 200 or between 185 and 215.

According to an embodiment of the invention, the solid solution strengthened ferritic ductile iron has a density of 7.0 or 7.1 kg/dm³.

According to an embodiment of the invention, the graphite size of the solid solution strengthened ferritic ductile iron is grade 6 to grade 7.

According to an embodiment of the invention, the solid solution strengthened ferritic ductile iron is EN-GJS-450-18, EN-GJS-500-14 or EN-GJS-600-10.

According to an embodiment of the invention, both of the fixed and orbiting scroll elements are made of solid solution strengthened ferritic ductile iron.

According to an embodiment of the invention, the fixed and orbiting scroll elements are made of the same solid solution strengthened ferritic ductile iron.

According to an embodiment of the invention, the fixed and orbiting scroll elements are made of two different solid solution strengthened ferritic ductile irons.

These and other advantages will become apparent upon reading the following description in view of the drawing attached hereto representing, as non-limiting example, an embodiment of a scroll compressor according to the invention.

### BRIEF DESCRIPTION OF THE DRAWINGS

The following detailed description of one embodiment of the invention is better understood when read in conjunction with the appended drawings being understood, however, that the invention is not limited to the specific embodiment disclosed.

FIG. 1 is a longitudinal section view of a scroll compressor according to the invention.

### DETAILED DESCRIPTION

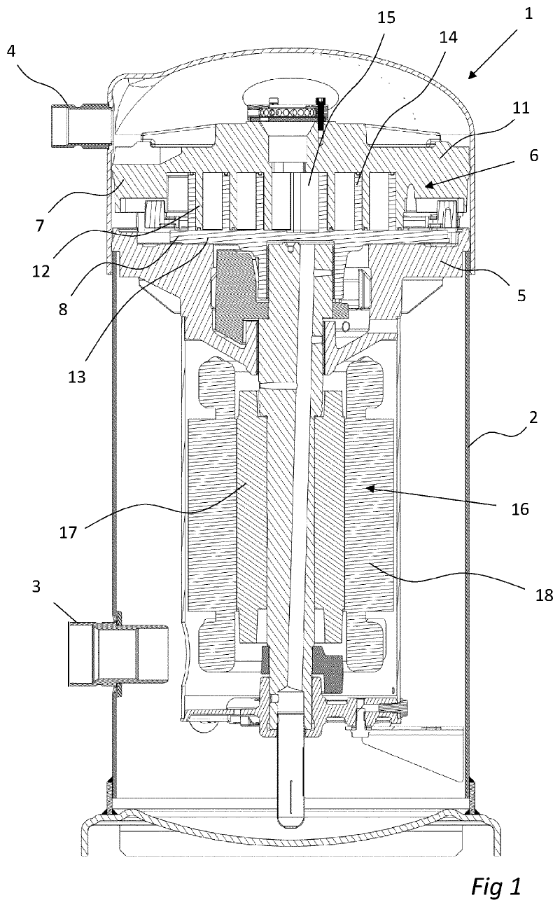

FIG. 1 shows a scroll compressor 1 comprising an enclosure 2 provided with a suction inlet 3 configured to supply the scroll compressor 1 with refrigerant to be compressed, and with a discharge outlet 4 configured to discharge compressed refrigerant.

The scroll compressor 1 also comprises a support frame 5 arranged within the enclosure 2 and secured to the enclosure 2, and a compression section 6 also arranged within the hermetic enclosure 2 and disposed above the support frame 5. The compression section 6 is configured to compress the refrigerant supplied by the suction inlet 3, and includes a fixed scroll element 7, which is fixed in relation to the enclosure 2, and an orbiting scroll element 8 supported by and in slidable contact with a thrust bearing surface 9 provided on the support frame 5.

The fixed scroll element 7 includes a first baseplate 11 having a lower face oriented towards the orbiting scroll element 8, and an upper face opposite to the lower face of the first baseplate 11. The fixed scroll element 7 also includes a first wrap portion 12 extending from the lower face of the first baseplate 11 towards the orbiting scroll element 8.

The orbiting scroll element 8 includes a second baseplate 13 having an upper face oriented towards the fixed scroll element 7, and a lower face opposite to the upper face of the second baseplate 13 and slidably mounted on the thrust bearing surface 9. The orbiting scroll element 8 also includes a second wrap portion 14 extending from the upper face of the second baseplate 13 towards the fixed scroll element 7. The second wrap portion 14 of the orbiting scroll element 8 intermeshes with the first wrap portion 12 of the fixed scroll element 7 to form a plurality of compression chambers 15 between them. Each of the compression chambers 15 has a variable volume which decreases from the outside towards the inside, when the orbiting scroll element 8 is driven to orbit relative to the fixed scroll element 7.

Furthermore the scroll compressor 1 includes a driving section 16 coupled with the orbiting scroll element 8 for moving the orbiting scroll element 8 in an orbiting motion during operation of the scroll compressor 1. Particularly, the driving section 16 includes a drive shaft 17 configured to drive the orbiting scroll element 8 in an orbiting motion, and an electric motor 18, which may be a variable-speed electric motor, coupled to the drive shaft 17 and configured to drive in rotation the drive shaft 17 about a rotational axis A.

According to an embodiment of the invention, both of the fixed and orbiting scroll elements 7, 8 are made of solid solution strengthened ferritic ductile iron (SSFDI), and for example of the same solid solution strengthened ferritic ductile iron.

The matrix of the solid solution strengthened ferritic ductile iron used to manufacture the fixed and orbiting scroll elements 7, 8 predominantly contains ferrite. The matrix of the solid solution strengthened ferritic ductile iron may contain at least 95% of ferrite, and for example at least 98% of ferrite. Advantageously, the matrix of the solid solution strengthened ferritic ductile iron only contains ferrite, and the microstructure of the solid solution strengthened ferritic ductile iron has a homogenous ferritic matrix.

According to an embodiment of the invention, the solid solution strengthened ferritic ductile iron has a tensile strength Rm between 400 and 650 MPa, advantageously between 425 and 625 MPa, and an elongation between 8% and 24%, and advantageously between 8% and 20%. In addition, the solid solution strengthened ferritic ductile iron has a 0.2 yield strength between 330 and 500 MPa, and a rotation-endurance bending strength at 20° C. between 200 and 230 MPa.

According to an embodiment of the invention, the solid solution strengthened ferritic ductile iron has a silicon content between 2.5% and 5%, and advantageously between 2.8 and 4.5%, and a copper content between 0.030% and 0.050%, and advantageously between 0.032 and 0.042%. Such silicon and copper contents allow to obtain a scroll element having a homogenous structure and to ensure a good cutting tool life.

The microstructure of the solid solution strengthened ferritic ductile iron used to manufacture the fixed and orbiting scroll elements 7, 8 may have a graphite shape of type V or of type VI, and may have a nodularity of at least 75%, advantageously of at least 80%. Advantageously, the graphite size of the solid solution strengthened ferritic ductile iron is grade 6 to grade 7.

According to an embodiment of the invention, the solid solution strengthened ferritic ductile iron has a Poisson's ratio between approximately 0.28 and approximately 0.29, and has an elasticity modulus of 170 GPa.

Advantageously, the solid solution strengthened ferritic ductile iron used to manufacture the fixed and orbiting scroll elements 7, 8 is chosen among EN-GJS-450-18, EN-GJS-500-14 and EN-GJS-600-10.

Mechanical properties of the EN-GJS-450-18, EN-GJS-500-14 and EN-GJS-600-10 are mentioned in the following table:

| | | | EN-GJS-450-18 | EN-GJS-500-14 | EN-GJS-600-10 |
|---|---|---|---|---|---|
| Tensile strength | Rₘ | MPa | 450 | 500 | 600 |
| 0.2 yield strength | R_{p0.2} | MPa | 350 | 400 | 470 |
| Elongation | A₅ | % | 18 | 14 | 10 |
| Elastic modulus | E | GPa | 170 | 170 | 170 |
| Brinell hardness | BHN | | 170-200 | 185-215 | 200-300 |
| Density | p | kg/dm³ | 7.1 | 7.0 | 7.0 |
| Rotation- | At 20° C. | MPa | 210 | 225 | 258 |
| endurance | | | | | |
| bending strength | | | | | |
| Poisson's ratio | v | | 0.28/0.29 | 0.28-0.29 | 0.28-0.29 |
| Silicon content | | % | 3.20 | 3.80 | 4.2 |

Using solid solution strengthened ferritic ductile iron to manufacture the fixed and orbiting scroll elements 7, 8 allows to improve machinability, and thus to decrease machining time. In addition, using solid solution strengthened ferritic ductile iron to manufacture the fixed and orbiting scroll elements allows increase tool life, which leads to an improve productivity compared to the one obtained with standard ductile cast irons having a matrix made of pearlite and ferrite.

Therefore, the compression section 6 according to the present invention has an improved mechanical strength while ensuring an improved machinability.

Of course, the invention is not restricted to the embodiment described above by way of non-limiting example, but on the contrary it encompasses all embodiments thereof. Particularly, only one of the fixed and orbiting scroll elements 7, 8 could be made of solid solution strengthened ferritic ductile iron, or the fixed and orbiting scroll elements 7, 8 could be made of two different solid solution strengthened ferritic ductile irons.

1. A scroll compressor comprising:
an enclosure,
a compression section arranged within the enclosure, the compression section comprising a fixed scroll element having a first baseplate and a first wrap portion extending from the first baseplate, and an orbiting scroll element having a second baseplate and a second wrap portion extending from the second baseplate], the fixed and orbiting scroll elements being intermeshed to form compression chambers, and
a driving section coupled with the orbiting scroll element for moving the orbiting scroll element in an orbiting motion during operation of the scroll compressor,
wherein at least one of the fixed and orbiting scroll elements is made of solid solution strengthened ferritic ductile iron.

2. The scroll compressor according to claim 1, wherein the solid solution strengthened ferritic ductile iron has a tensile strength Rm between 400 and 650 MPa, advantageously between 425 and 625 MPa.

3. The scroll compressor according to claim 1, wherein the solid solution strengthened ferritic ductile iron has a silicon content between 2.5% and 5%, and advantageously between 2.8 and 4.5%.

4. The scroll compressor according to claim 1, wherein the solid solution strengthened ferritic ductile iron has an elongation of at least 8%.

5. The scroll compressor according to claim 1, wherein the solid solution strengthened ferritic ductile iron has a 0.2 yield strength between 330 and 500 MPa.

6. The scroll compressor according to claim 1, wherein the matrix of the solid solution strengthened ferritic ductile iron predominantly contains ferrite.

7. The scroll compressor according to claim 6, wherein a maximum pearlite content in the matrix of the solid solution strengthened ferritic ductile iron is of 5%.

8. The scroll compressor according to claim 6, wherein the matrix of the solid solution strengthened ferritic ductile iron only contains ferrite.

9. The scroll compressor according to claim 1, wherein the solid solution strengthened ferritic ductile iron is EN-GJS-450-18, EN-GJS-500-14 or EN-GJS-600-10.

10. The scroll compressor according to claim 1, wherein both of the fixed and orbiting scroll elements are made of solid solution strengthened ferritic ductile iron.
